(19) United States
(12) Patent Application Publication
(10) Pub. No.: US 2018/0259774 A1
(43) Pub. Date: Sep. 13, 2018

(54) VIRTUAL REALITY DISPLAY DEVICE AND MANUFACTURING METHOD THEREOF

(71) Applicants: BOE TECHNOLOGY GROUP CO., LTD., Beijing (CN); Beijing BOE Display Technology Co. Ltd., Beijing (CN)

(72) Inventors: Xiang FENG, Beijing (CN); Sha LIU, Beijing (CN); Ruizhi YANG, Beijing (CN); Xiao SUN, Beijing (CN); Zhaokun YANG, Beijing (CN); Qiang ZHANG, Beijing (CN); Yun QIU, Beijing (CN)

(21) Appl. No.: 15/790,157

(22) Filed: Oct. 23, 2017

(30) Foreign Application Priority Data
Mar. 10, 2017 (CN) 201710142928.7

(51) Int. Cl. G02B 27/01; G02B 27/00; G02B 5/18

(52) U.S. Cl. CPC G02B 27/0172; G02B 5/1876; G02B 27/0012

(57) ABSTRACT

A virtual reality display device and manufacturing method thereof, the virtual reality display device includes: a display panel, a support structure formed on the display panel, and a Fresnel lens formed on the support structure.

### CROSS-REFERENCE TO RELATED APPLICATIONS

The present application claims priority to Chinese Patent Application No. 201710142928.7, filed Mar. 10, 2017, titled “Virtual reality display device and manufacturing method thereof”, the entire contents of which are incorporated herein by reference.

### TECHNICAL FIELD

The present disclosure generally relates to the field of virtual reality technology, and more particularly, to a virtual reality display device and manufacturing method thereof.

### BACKGROUND

VR (Virtual Reality), is the technology of using computer simulation to produce a virtual world of three-dimensional space, providing users with vision and other sensory simulation, so that users feel as if they are immersive, and can simulate the real scene to observe things within the three-dimensional space unrestrictedly.

With the increasing demand for display equipment, VR equipment comes to the market gradually in 2015. For the technology development direction of headset VR equipment, one way is to commit to improving the user's feeling of immersion and realism in the virtual world, another way is to achieve the miniaturization and lightweight of the headset VR equipment to further improve the user experience.

On one hand, for the lightweight of the headset VR equipment, the organic electroluminescent display panel and micro-LED display panel are more in line with technical requirements, which will be introduced respectively below.

Organic electroluminescence display technology, known as a flat display technology with fantastic display characteristics, is also known as an OLED (organic light emitting diode) as its light-emitting mechanism is similar to a light-emitting diode (LED). The OLEDs have the advantages of thinness and lightness, active emission, wide viewing angle, fast response, low energy consumption, low temperature performance and anti-seismic performance, potential flexible design or the like. Since 2000, the OLED has drawn wide attention in the field, and begun to enter the stage of industrialization.

With the continuous development of technology, the new display technology micro-LED display device came into being. The Micro-LED display device is also called a Micro-LED. The Micro-LED technology refers to that the thinness, miniaturization and matrixing of the LED is achieved by integrating high-density small size LED arrays on one chip. The pixel distance of the Micro-LED display device is decreased from the millimeter level to the micron level, and the volume of the Micro-LED display device is 1% of that of the current mainstream LED. Each pixel can be addressed and emit light separately. The Micro-LED display device have the advantages of low power consumption (power consumption is only one-tenth of that of the LCD), high brightness, high resolution, high color saturation and no color loss, faster response, longer lifespan, higher efficiency and the like. Currently, many manufacturers regard the Micro-LED display device as the next generation of display technology.

On the other hand, as for the miniaturization of the VR equipment, in order to reduce the size of the headset VR equipment, the distance between the display screen and the human eye will be designed to be relatively small, but objects too close to the eyes cannot be imaged in the retina due to the human lens, which restricts the further miniaturization of the headset VR equipment.

Therefore, a novel virtual reality display device is required.

It is to be noted that the information disclosed in the above-mentioned background section is for the purpose of reinforcing the understanding of the background of the present disclosure and may therefore include information that does not constitute related art known to those of ordinary skill in the art.

### SUMMARY

The present disclosure provides a virtual reality display device and manufacturing method thereof.

Other features and advantages of the present disclosure will become apparent from the following detailed description, or in part, from practice of the present disclosure.

According to a first aspect of the present disclosure, there is provided a virtual reality display device including:

a display panel;

a support structure formed on the display panel; and

a Fresnel lens formed on the support structure.

According to one embodiment of the present disclosure, the support structure surrounds an effective display region of the display panel.

According to one embodiment of the present disclosure, the support structure is made of a material including glass or polymethyl methacrylate.

According to one embodiment of the present disclosure, the support structure is made of a material including glass and constructed by an outer wall and an inner wall surrounding the effective display region of the display panel and the glass between the outer wall and the inner wall.

According to one embodiment of the present disclosure, a height of the support structure can be adjusted by an optical design, in the way, contents on the display panel may be focused on a user's retina by the Fresnel lens.

According to one embodiment of the present disclosure, the Fresnel lens is made of a material of polymethyl methacrylate.

According to one embodiment of the present disclosure, the Fresnel lens is made of a material of glass.

According to one embodiment of the present disclosure, surface threads of the Fresnel lens are prepared by etching.

According to one embodiment of the present disclosure, the display panel is an organic electroluminescent display panel or a Micro-LED display panel.

According to a second aspect of the present disclosure, there is provided a method for manufacturing a virtual reality display device, including:

forming a support structure on a display panel; and

fitting a Fresnel lens on the support structure.

According to one embodiment of the present disclosure, the forming a support structure on a display panel includes: forming an outer wall and an inner wall surrounding an effective display region of the display panel on the display panel by photoresist or ink jet printing, in a way that a space between the outer wall and the inner wall forming a groove, placing glass powder in the groove, so that the outer wall, the glass powder and the inner wall forming the support structure.

According to one embodiment of the present disclosure, the fitting a Fresnel lens on the support structure includes: melting the glass powder by laser to joint the Fresnel lens and the support structure.

According to one embodiment of the present disclosure, surface threads of the Fresnel lens are prepared by etching.

According to still other embodiments of the present disclosure, a Fresnel lens is prepared by glass, the preparation process of which can be combined with the packaging process in the OLED or Micro-LED manufacture procedure.

### BRIEF DESCRIPTION OF THE DRAWINGS

The above and other objects, features and advantages of the present disclosure will become more apparent by describing in detail the exemplary embodiments thereof with reference to the accompanying drawings.

FIG. 1 schematically shows the operating principle of a Fresnel lens.

FIG. 2 is a schematic top view of a virtual reality display device prior to fitting a Fresnel lens according to an exemplary embodiment of the present disclosure.

FIG. 3 is a schematic top view of a Fresnel lens of a virtual reality display device according to an exemplary embodiment of the present disclosure.

FIG. 4 schematically shows the cross-sectional view of a virtual reality display device and the joint of a Fresnel lens and a display panel according to an exemplary embodiment of the present disclosure.

FIG. 5 schematically shows a flow chart of a method for manufacturing a virtual reality display device according to an exemplary embodiment of the present disclosure.

FIG. 6 is a schematic diagram of an integrated circuit bonding scheme for a virtual reality display device according to an exemplary embodiment of the present disclosure.

### DETAILED DESCRIPTION

Now exemplary embodiments will be described more fully with reference to the accompanying drawings. However, the exemplary embodiments may be practiced in many forms and should not be construed as limited to the examples set forth herein. Rather, the provision of such embodiments makes the present disclosure more thorough and complete, and may fully convey the concepts of the exemplary embodiments to those skilled in the art. The drawings are merely illustrative of the present disclosure and are not necessarily drawn to scale. The same reference numerals in the drawings denote the same or similar parts, and thus repeated description thereof will be omitted.

In addition, the features, structures, or characteristics described may be combined in one or more embodiments in any suitable manner. In the following description, numerous specific details are set forth to give a full understanding of the embodiments of the present disclosure. However, those skilled in the art will appreciate that one or more of the particular details may be omitted by practicing the technical solution of the present disclosure, or other methods, components, devices, steps, and the like may be used. In other instances, in order to avoid the various aspects of the disclosure from being obscured, well-known structures, methods, devices, implementations, materials, or operations are not described nor shown in detail.

In the following description, when a predetermined part “includes” a predetermined component, the predetermined part does not exclude other components, but may further include other components unless otherwise stated.

The thickness and size of each layer shown in the figure may be exaggerated, omitted or schematically drawn for convenience and clarity. In addition, the size of the element does not fully reflect the actual size.

In the description of the embodiments, it should be understood that when a layer (or film), a region, or a plate is referred to as being “on” another part, it may be “directly” or “indirectly” on the another part, or one or more intermediate layers may also be present. Rather, it should be understood that one or more of the intermediate layers may not exist when a part is referred to as being “directly on” another part.

The present disclosure provides a virtual reality display device and a manufacturing thereof. The virtual reality display device of the present disclosure includes: a display panel; a support structure formed on the display panel; and a Fresnel lens formed on the support structure. In the virtual reality display device of the present disclosure, as a Fresnel lens is integrated in the display device, and the Fresnel lens makes the image quite close to the human eye can also be imaged on the retina, thus the size of the VR equipment can be reduced and the application value of the display module in the virtual reality field can be improved.

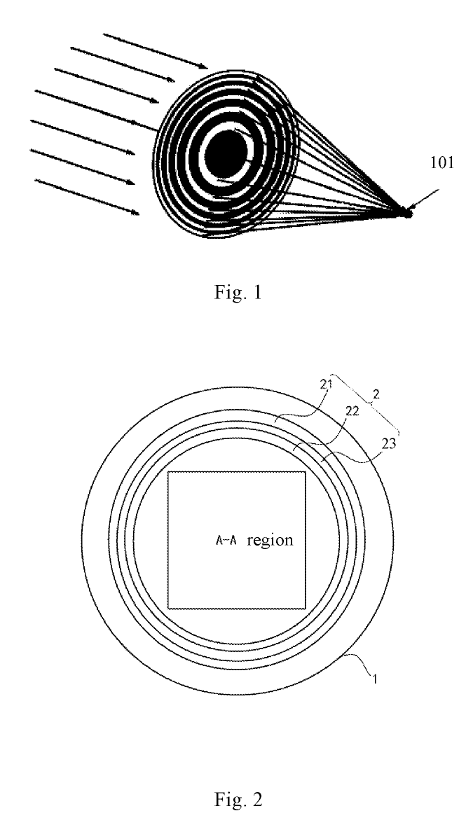

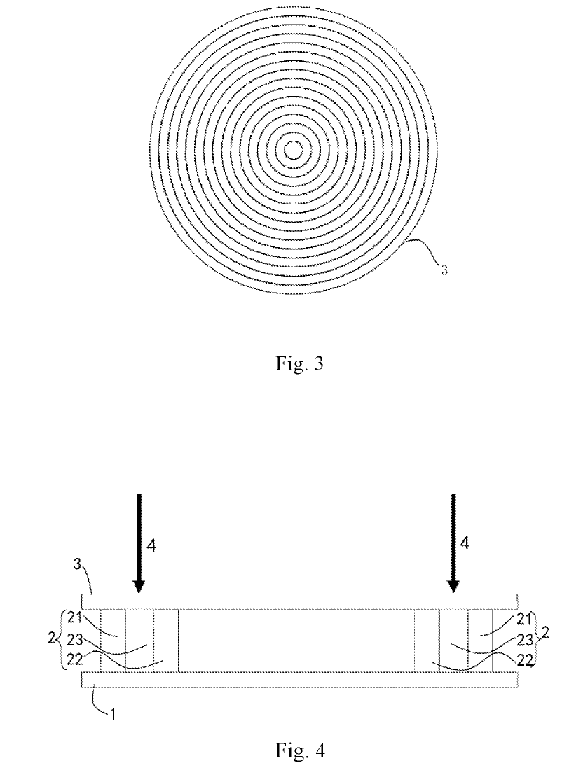

The virtual reality display device of the present disclosure will now be described in detail with reference to FIGS. 1-4. FIG. 1 schematically shows the operating principle of a Fresnel lens. FIG. 2 is a schematic top view of a virtual reality display device prior to fitting a Fresnel lens according to an exemplary embodiment of the present disclosure. FIG. 3 is a schematic top view of a Fresnel lens of a virtual reality display device according to an exemplary embodiment of the present disclosure. FIG. 4 schematically shows the cross-sectional view of a virtual reality display device and the joint of a Fresnel lens and a display panel according to an exemplary embodiment of the present disclosure.

First, the principle of the Fresnel lens and the reason for integrating the Fresnel lens in the virtual reality display device of the present disclosure will be described with reference to FIG. 1.

A Fresnel lens, also known as thread lens, is invented by the French physicist Augustin Fresnel. In 1822, Augustin Fresnel first used the design of this lens to create a glass Fresnel lens system—a lighthouse Lens. As shown in FIG. 1, the Fresnel lens converges the incident light into a bright spot 101. Most of Fresnel lenses are sheets which are injection molded by a polyolefin material such as PMMA (that is polymethyl methacrylate), and there is also a Fresnel lens made of glass. One surface of the lens is a smooth surface, the other surface is burned with concentric circles from small to large, and its texture is designed by using light interference and diffraction and according to the relative sensitivity and reception angle requirements. It requires excellent performance of the lens, a high-quality lens must have smooth surface and clear texture, and may have a thickness of about 1 mm (varying with the usage). The high-quality lens has the characteristics of a larger area, a smaller thickness and a larger detection range.

The Fresnel lens has two functions. One is to focus, the other is to divide the detection region into a number of bright regions and dark regions, so that the objects moving into the detection region can generate variable passive infrared ray signals on a PIR (passive Infrared Ray) in the form of changing temperature A Fresnel lens in many cases is equivalent to an infrared and visible light convex lens, the effect of the Fresnel lens is better, but the cost of the Fresnel lens is much lower than that of an ordinary convex lens.

The principle of the Fresnel lens is based on a Fresnel zone sheet which has an effect similar to the lens that allows the incident light to converge and produce great light intensity. The basic idea of the Fresnel lens is quite simple. Imagine taking a plastic magnifying glass and cutting it into a hundred concentric rings (like growth rings in a tree) sheets. Each ring is slightly smaller than the ring beside it, and converges the light to the center. Now, each ring is taken out and modified, so that it has the same thickness with the rest of the rings and one side of each ring is flat. In order to maintain the ability of the ring to converge the light to the center, the angle of the slope of each ring will be different. Now, if all the rings are stacked together, a Fresnel lens may be obtained. The lens can also be made particularly large. A large Fresnel lens is often used as a solar concentrator.

Briefly, the virtual reality display device of the present disclosure utilizes the focusing function of the Fresnel lens and integrates the Fresnel lens in the display device of the VR equipment, so that images quite close to the human eye can also be imaged in the retina. Thus, the size of the VR equipment can be reduced, the miniaturization requirement and technical development trend of the headset VR equipment can be achieved. At the same time, the Fresnel lens not only has a much lower cost than a conventional convex lens, but also has a smaller thickness, which also meets the requirements for the miniaturization and lightweight and technical development trends of the headset VR equipment.

The virtual reality display device integrating with the Fresnel lens will now he described in detail with reference to FIGS. 2-4.

As shown in FIGS. 2-4, the virtual reality display device includes: a display panel 1; a support structure 2 formed on the display panel 1; and a Fresnel lens 3 formed on the support structure 2. The support structure 2 is made of a material including glass or polymethyl methacrylate and the like to support the Fresnel lens 3 on the display panel 1, and hermetically joints the display panel 1 and the Fresnel lens 3 to prevent degradation of image quality. In the case where the material forming the support structure 2 includes glass, the support structure 2 may be constructed by an outer wall and an inner wall surrounding the effective display region of the display panel 1, and the glass between the outer wall and the inner wall. Meanwhile, the support structure 2 is also used to maintain a suitable distance between the display panel 1 and the Fresnel lens 3 to ensure that the image can be clearly and effectively obtained on the retina of the eyes of the user wearing the headset VR equipment of the virtual reality display device.

FIG. 2 is a schematic top view of a virtual reality display device prior to fitting a Fresnel lens according to an exemplary embodiment of the present disclosure, which shows a new design idea of the virtual reality display device: using a circular display panel 1, the effective display region in the display panel 1, that is, an A-A region, is a square region and located in the dead center of the display panel 1. The outer wall 21 and the inner wall 22 surrounding the effective display region (that is, the A-A region) of the display panel is formed on the display panel by photoresist or ink jet printing. The space between the outer wall and the inner wall forms a groove, glass powder 23 is placed in the groove. The glass powder 23 hot melted by radiation of the laser 4. The outer wall and the inner wall together form the support structure 2. The support structure 2 surrounds but does not block the effective display region (that is, the A-A region) of the display panel 1. The height of the support structure 2 can be adjusted by an optical design, so that the contents on the display panel 1 can be focused and imaged on the retina by the Fresnel lens 3. Specifically, when the specific parameters of the used Fresnel lens have been determined, that is, in the case where the main focal length f of the Fresnel lens has been determined, through the Fresnel lens imaging formula 1/h=1/r₀, the height h of the support structure 2 is adjusted according to the distance r₀ between the virtual reality display device and the user's eyes which is determined by the size of the headset VR equipment to be designed. In this way, even if the distance between the virtual reality display device in the headset VR equipment and the user's eyes is smaller, the problem that it is difficult to focus imaging on the retina may not happen, thereby greatly reducing the size of the VR equipment.

According to an embodiment of the present disclosure, the display panel 1 in FIG. 2 may be an organic electroluminescent display, i.e., an OLED device, or a micro-LED display device, i.e., a Micro-LED device. The present disclosure is not limited to this, and other display devices may also be provided as long as they can meet the requirements for the miniaturization and lightweight of the VR equipment. In addition, the shape of the display panel 1 is not limited to a circle, and may also be a square, a rectangle or other desired shape. Meanwhile, the shape of the effective display region (that is, the A-A region) of the display panel 1 is not limited to a square, and it may also be a circular, rectangle, or other desired shapes.

FIG. 3 is a schematic diagram of a Fresnel lens. The Fresnel lenses can be prepared by glass, and the threads of the Fresnel lens are prepared by etching.

The Fresnel lens itself is evolved through the lens, although the Fresnel lens is now made with PMMA (that is polymethyl methacrylate), it can also be made of glass, so that it can be combined with the packaging process in the OLED or the Micro-LED manufacture procedure. Moreover, the surface threads of the Fresnel lens can be prepared using an etching process as the requirement for the surface thread accuracy of the Fresnel lens is not high. Those skilled in the art can produce a glass Fresnel lens with a flat panel display (FPD) production line, thus the integration level of the display panel can be enhanced, the cost and time of the process can be reduced, and the production cost can be reduced.

It is to be noted that when the display panel 1 is an OLED, because the Fresnel lens 3 made of PMMA (that is, the polymethyl methacrylate) cannot meet the requirements for packaging the OLED, the Fresnel lens 3 above the display panel 1 must be of glass material. However, when the display panel 1 is a Micro-LED, because the requirements for packaging the inorganic Micro-LED are not high and the PMMA can also meet the requirements, the Fresnel lens 3 above the display panel 1 can be of glass material, or be of PMMA material. In this case, the support structure 2 can be made of PMMA correspondingly.

FIG. 4 schematically shows the cross-sectional view of a virtual reality display device and the joint of a Fresnel lens and a display panel according to an exemplary embodiment of the present disclosure.

As shown in FIG. 4, the outer wall 21 and the inner wall 22 formed by photoresist or ink jet printing and the glass powder 23 hot melted by radiation of the laser 4 together form the support structure 2. The support structure 2 is used to support the Fresnel lens 3 on the display panel 1 and hermetically joint the display panel 1 and the Fresnel lens 3 to prevent degradation of image quality due to the entry of water vapor or dust. Meanwhile, the support structure 2 is also used to maintain a suitable distance between the display panel 1 and the Fresnel lens 3 to ensure obtaining a clear and effective image on the eye retina of a user wearing the headset VR equipment using the virtual reality display device.

Next, the process of forming the glass Fresnel lens 3 and the display panel 1 into a cell will be described. Specifically, as shown in FIG. 4, the process of forming the Fresnel lens 3 and the display panel 1 into a cell is to heat and melt the glass powder 23 in the groove is by the laser 4 so that the glass Fresnel lens 3, the display panel 1 can be hermetically jointed with the upper and lower surfaces of the support structure 2, respectively, to complete the forming the glass Fresnel lens 3 and the display panel 1 into a cell.

By the formation of the above-described support structure 2 and the forming the glass Fresnel lens 3 and the display panel 1 into a cell, the process cost is reduced while ensuring the airtightness of the joint, and avoiding damage to the display panel possibly caused by other formations and the ways of forming a cell.

In general, since the display device used in the headset VR equipment does not need a touch plate or a touch and control plate, nor an anti-reflection layer/film designed for the OLED or Micro-LED, the Fresnel lens 3 can be used without the need to add layers/films and parts, such as touch sensors, polarizers and the like, which are generally included in a typical display device (such as display screens of mobile phones, tablet PCs, etc.). However, the present disclosure is not limited thereto, the required layers/films and parts can be added according to practical application needs.

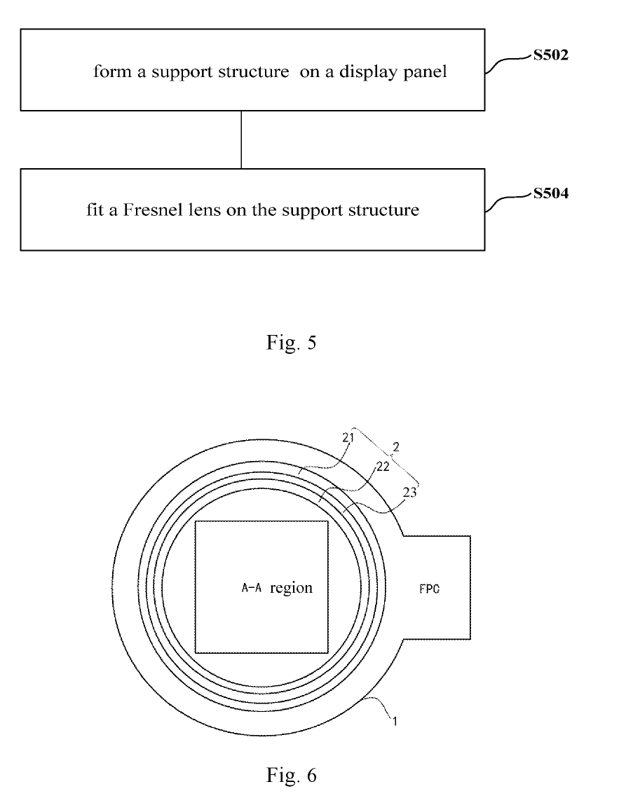

In addition, the present disclosure further provides a method for manufacturing a virtual reality display device. FIG. 5 schematically shows a flow chart of a method for manufacturing a virtual reality display device according to an exemplary embodiment of the present disclosure.

As shown in FIG. 5, a method for manufacturing a virtual reality display device includes the following steps.

At a step of S502, a support structure is formed on a display panel.

Specifically, first, a circular display panel 1 is prepared, the effective display region (that is, an A-A region) in the display panel 1 is a square region and located in the dead center of the display panel 1. Then, the outer wall 21 and the inner wall 22 surrounding the effective display region (that is, the A-A region) of the display panel is formed on the display panel by photoresist (i.e., PR) or ink jet printing. The space between the outer wall and the inner wall forms a groove which is configured to accommodate glass powder 23. Finally, the glass powder 23 is placed in the groove. The glass powder 23 hot melted by radiation of the laser 4 in the flowing step, the outer wall 21 and the inner wall 22 together form the support structure 2. When the support structure 2 is being formed, it is ensured that the support structure 2 surrounds but does not block the effective display region (that is, the A-A region) of the display panel 1.

In the embodiment, the height of the support structure 2 can be adjusted by an optical design, so that the contents on the display panel 1 can be focused and imaged on the retina by the Fresnel lens 3. In this way, even if the distance between the virtual reality display device in the headset VR equipment and the user's eyes is quite small, the problem that it is difficult to focus imaging on the retina may not happen, thereby greatly reducing the size of the VR equipment.

The display panel 1 may be an organic electroluminescent display, i.e., an OLED device, or a micro-LED display device, i.e., a Micro-LED device. The present disclosure is not limited to this, and other display devices may also be provided as long as they can meet the requirements for the miniaturization and lightweight of the VR equipment. In addition, the shape of the display panel 1 is not limited to a circle, and may also be a square, a rectangle or other desired shape. Meanwhile, the shape of the effective display region (that is, the A-A region) of the display panel 1 is not limited to a square, and it may also be a circular, rectangle, or other desired shapes.

At a step of S504, the Fresnel lens is fitted on the support structure.

After the support structure 2 is formed, the prepared Fresnel lens 3 is covered on the support structure 2, and finally, the processing of forming the glass Fresnel lens 3 and the display panel 1 into a cell is completed by the irradiation of the laser 4. As shown in FIG. 4, the glass powder 23 in the groove is melted by the laser 4 so that the glass Fresnel lens 3 can be hermetically jointed with the support structure 2, to complete the forming the glass Fresnel lens 3 and the display panel 1 into a cell.

By the formation of the above-described support structure 2 and the forming the glass Fresnel lens 3 and the display panel 1 into a cell, the process cost is reduced while ensuring the airtightness of the joint, and avoiding damage to the display panel possibly caused by other formations and the ways of forming a cell.

Although the Fresnel lens is now made with PMMA (that is polymethyl methacrylate), it can also be made entirely of glass so that it can be combined with the packaging process in the OLED or the Micro-LED manufacture procedure. Moreover, the surface threads of the Fresnel lens can be prepared using an etching process as the requirement for the surface thread accuracy of the Fresnel lens 3 is not high. Those skilled in the art can produce a glass Fresnel lens 3 with a flat panel display (FPD) production line, thus the integration level of the display panel 1 can be enhanced, the cost and time of the process can be reduced, and the production cost can be reduced.

It is to be noted that when the display panel 1 is an OLED, because the Fresnel lens 3 made of PMMA (that is, the polymethyl methacrylate) cannot meet the requirements for packaging the OLED, the Fresnel lens 3 above the display panel 1 must be of glass material. However, when the display panel 1 is a Micro-LED, because the requirements for packaging the inorganic Micro-LED are not high and the PMMA can also meet the requirements, the Fresnel lens 3 above the display panel 1 can be of glass material, or be of PMMA material. In this case, the support structure 2 can be made of PMMA correspondingly.

Finally, the integrated circuit binding mode of the virtual reality display device will be described with reference to FIG. 6.

FIG. 6 shows a schematic diagram of an integrated circuit bonding and wiring scheme of a virtual reality display device according to an exemplary embodiment of the present disclosure, wherein the virtual reality display device is connected to an external circuit through a flexible printed circuit board FPC.

As shown in FIG. 6, the virtual reality display device of the present disclosure can use the bonding and wiring scheme of a conventional display, which will not be described herein. The present disclosure therefore does not affect the bonding and wiring of the integrated circuit (IC), and nor incur additional process cost and time.

In view of the above, according to some embodiments of the present disclosure, since the Fresnel lens is integrated in the display device, the Fresnel lens makes the image quite close to the human eye can also be imaged on the retina, thus the size of the VR equipment can be reduced and the application value of the display module in the virtual reality field can be improved, and the user experience is further improved.

According to still other embodiments of the present disclosure, a Fresnel lens is prepared by glass, the preparation process of which can be combined with the packaging process in the OLED or Micro-LED manufacture procedure to enhance the integration level of the display device.

Other embodiments of the present disclosure will be readily apparent to those skilled in the art upon consideration of the specification and practice of the present disclosure disclosed herein. This application is intended to cover any variations, usages, or adaptations of the present disclosure that follow the general principles of the present disclosure and include the common general knowledge or conventional techniques disclosed in this disclosure. The specification and examples are to be regarded as illustrative only, and the true scope and spirit of the present disclosure is specified by the appended claims.

It is to be understood that the present disclosure is not limited to the precise constructions described above and illustrated in the accompanying drawings, and that various modifications and changes may be made without departing from the scope thereof. The scope of the present disclosure is limited only by the appended claims.

What is claimed is:

1. A virtual reality display device, comprising:
a display panel;
a support structure formed on the display panel; and
a Fresnel lens formed on the support structure

2. The virtual reality display device according to claim 1, wherein the support structure surrounds an effective display region of the display panel.

3. The virtual reality display device according to claim 1, wherein the support structure is made of a material comprising glass or polymethyl methacrylate.

4. The virtual reality display device according to claim 3, wherein the support structure is made of a material comprising glass and is constructed by an outer wall and an inner wall surrounding the effective display region of the display panel and glass between the outer wail and the inner wall.

5. The virtual reality display device according to claim 1, wherein a height of the support structure is adjustable with an optical design, in a way to focus contents on the display panel on a user's retina through the Fresnel lens.

6. The virtual reality display device according to claim 1, wherein the Fresnel lens is made of a material of polymethyl methacrylate.

7. The virtual reality display device according to claim 1, wherein the Fresnel lens is made of a material of glass.

8. The virtual reality display device according to claim 7, wherein surface threads of the Fresnel lens are prepared by etching.

9. The virtual reality display device according to claim 1, wherein the display panel is an organic electroluminescent display panel or a Micro-LED display panel.

10. A method for manufacturing a virtual reality display device, comprising:
forming a support structure on a display panel; and
fitting a Fresnel lens on the support structure.

11. The method for manufacturing a virtual reality display device according to claim 10, wherein the step of forming a support structure on a display panel comprises: forming an outer wall and an inner wall surrounding an effective display region of the display panel on the display panel by photoresist or ink jet printing, in a way that a space between the outer wall and the inner wall forming a groove, placing glass powder in the groove, so that the outer wall, the glass powder and the inner wall forming the support structure.

12. The method for manufacturing a virtual reality display device according to claim 11, wherein the step of fitting a Fresnel lens on the support structure comprises: melting the glass powder by laser to joint the Fresnel lens and the support structure.

13. The method for manufacturing a virtual reality display device according to claim 10, wherein before the step of fitting a Fresnel lens on the support structure, the method further comprises preparing surface threads of the Fresnel lens by etching.
